(19) United States
(12) Patent Application Publication
(10) Pub. No.: US 2019/0286928 A1
(43) Pub. Date: Sep. 19, 2019

(54) MOBILE MICRO-LOCATION

(71) Applicant: Microsoft Technology Licensing, LLC, Redmond, WA (US)

(72) Inventors: Julie Anna HUBSCHMAN, Seattle, WA (US); Alex Jungyeop WOO, Seattle, WA (US); Zachary Thomas Zimmerman, Seattle, WA (US); Janet SCHNEIDER, Bellevue, WA (US); Saqib SHAIKH, London (GB); Donna Katherine LONG, Redmond, WA (US); Kevin Jonathan JEYAKUMAR, Bellevue, WA (US)

(21) Appl. No.: 15/922,654

(22) Filed: Mar. 15, 2018

(51) Int. Cl. G06K 9/00; H04W 4/02

(52) U.S. Cl. CPC G06K 9/00993; G06Q 50/30; G06K 9/00288; H04W 4/02

(57) ABSTRACT

A location system includes two entities that are attempting to co-locate one another. The entities detect and transmit locating information, such as image/video data identifying information, image/video data of the environment, audio data of the environment, or detected signals, to either the other entity or a micro-location server. Analysis is performed on the signals to determine whether the entities are in the same or a similar proximity. Example analysis includes facial recognition of a user (a first entity) in video data captured by a vehicle (a second entity). If the data satisfies a location matching condition (the entities are in a close proximity), then a location refining signal is generated and transmitted to one or both of the entities.

### BACKGROUND

When one entity is attempting to locate another entity, such as a ride-sharing service driver attempting to locate passenger requesting a pickup, the driver and/or the passenger may utilize low granularity global positioning system (GPS) data to enable general co-location. However, when in a general location, it is sometimes difficult for the two entities to cross-identify one another. In the example of the driver and the passenger, if the passenger is located in a crowded area, it may be difficult for the driver to identify the passenger in the crowd. Similarly, if the vehicle is on a crowded street, it may be difficult for the passenger to identify the car that is designated to pick the passenger up.

### SUMMARY

Implementations described and claimed herein address the foregoing problems by providing a location method that includes monitoring second entity locating data corresponding to the second entity. At least some of the second entity locating data being derived from a physical proximity of the second entity by the one or more sensors coupled to the at least one computing device. The method further includes analyzing the monitored second entity locating data and received first entity locating data corresponding the first entity to determine whether the first entity locating data and the second entity locating data satisfy a location matching condition. Satisfaction of the location matching condition signals the first entity is within the physical proximity detectable by the one or more sensors coupled to the at least one computing device. The method further includes generating a location refining signal based on the second entity locating data and the first entity locating data responsive to the second entity locating data and the first entity locating data satisfying the location matching condition. The location refining signal provides guidance to at least one of the second entity and the first entity.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example environment for mobile micro-location.

FIG. 2 illustrates another example environment for mobile micro-location.

FIG. 3 illustrates another example environment for mobile micro-location.

FIG. 4 illustrates another example environment for mobile micro-location.

FIG. 5 illustrates example location operations.

FIG. 6 illustrates a block diagram of example systems utilized for mobile micro-location.

FIG. 7 an example system that may be useful in implementing the described technology.

### DETAILED DESCRIPTIONS

A system for locating a first entity by a second entity analyzes locating data of each entity to determine whether the first entity has located or identified the second entity. The locating data may include video, image, audio, signal, or other entity identifying data that is detected by one or more sensors of a device connected to or utilized by the entity. In the example of the driver and the passenger, the locating data of the passenger may include data detectable by a mobile device of the passenger, such as passenger identifying data (e.g., a picture of the passenger), video or image data of the passenger's surroundings or view (e.g., environment data), ambient audio data of the passenger's surroundings, or other signal data of signals detectable by the mobile device (e.g., cell tower signal strength, Wi-Fi signals), etc. Locating data of the vehicle may include vehicle identifying data (e.g., car make and color, car tag information), video or image data detected by a camera mounted to the vehicle, audio data, signal data, environment data, etc. Such data may be received at and analyzed by micro-location servers.

The micro-location servers analyze the data to determine whether the data satisfies a location matching condition. Such analysis may include conducting facial recognition analysis, pattern matching, machine learning, etc. For example, the micro-location servers may receive real-time video data from a camera attached to the vehicle of the driver. The micro-location servers may further access profile data including a picture of the passenger and/or receive a current picture of the passenger. To determine whether the location matching condition is satisfied, the micro-location servers analyze the video data to determine whether the passenger is included in the video data based on the picture of the passenger and using facial recognition techniques. If the passenger is identified in the video data, then the location matching condition is satisfied, and a location refining signal is generated by the micro-location server. The location refining signal may provide further guidance to the passenger and/or the driver of the car to further co-locate each other. For example, the location refining signal may include user interface instructions to guide one or both of the passenger and the driver to each other. User interface instructions may include audio guidance (voice assisted guidance), beeps, arrows and distance indicators on a UI display, etc. To further describe the example, the passenger may be visually impaired and not be able to visually identify the vehicle. Thus, the location refining signal may audibly describe the location of the incoming vehicle to the passenger.

Other methods of micro-location are contemplated herein. For example, locating data may include signal data from one or both of the entities. A first entity may transmit identification of Wi-Fi signals detectable in a current location. The second entity, as its moving in a general location of the first entity, may detect different Wi-Fi signals and transmit the detected signals as locating data to the micro-location servers. The detected signals are analyzed to determine when the signals satisfy the location matching condition, and location refining signals are generated responsive to detection of satisfaction of the location matching condition. Furthermore, the system described herein may utilize signals and other data to triangulate a location of one or both of the entities for micro-location. These and other implementations are described further with respect to the figures.

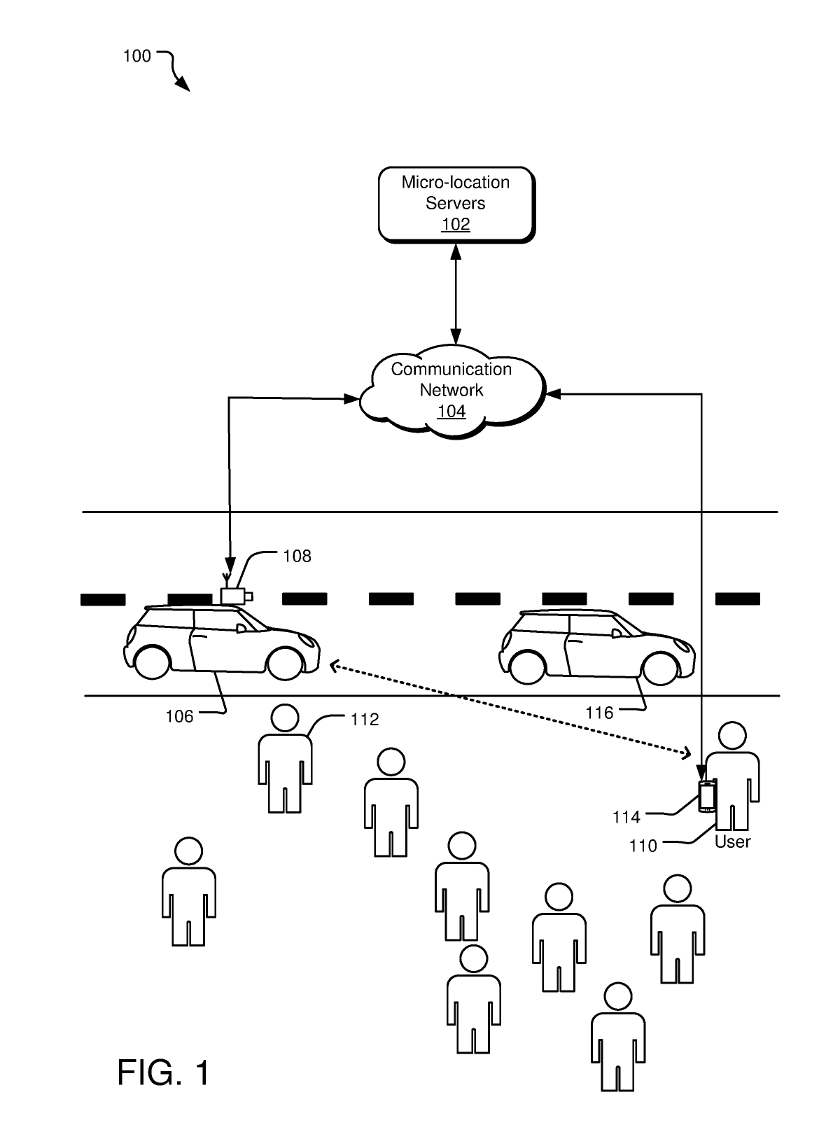

FIG. 1 illustrates an example environment for mobile micro-location. The environment 100 includes a user 110 and bystanders (e.g., a bystander 112), and vehicles 106 and 116. The user 110 carries a mobile device 114 (e.g., a computing device) that may be any type of device capable of communicating using wireless communication protocols (e.g., 3G, 4G, 5G, long-term evolution (LTE), Wi-Fi, Near Field Communication (NFC), Bluetooth, global positioning system (GPS)) such as tablet, smartphone, laptop, and other similar devices. The mobile device 114 utilizes one or more wireless communication protocols to communicate with other devices and servers over a communication network 104. Micro-location servers 102 communicate over the communication network 104 to support micro-location between two or more entities such as the user 110 and the vehicle 106.

In the illustrated implementation, the user 110 utilizes the mobile device 114 to hail a vehicle. For example, the user 110 may have an application installed on the mobile device 114 that is configured for hailing a vehicle. Example applications that may be installed on the mobile device 114 include a ride-sharing service application, a taxi application, a car rental application, etc. In some example implementations, the user 110 transmits a request over the communication network 104 for a ride, vehicle, etc. The request may include current GPS location information of the user 110 detected via GPS instrumentation of the mobile device 114. It should be understood that other systems for detecting location may be utilized or that the user 110 may enter a location via a user interface of the mobile device 114. The user 110 may also transmit user identifying data over the communication network 104. For example, the user transmits a current picture of the user's face or surroundings. In some example implementations, a user profile may be associated with the user 110 that is managed by the application installed on the device and/or the micro-location servers 102. The user profile may be stored on the device and/or a server such as the micro-location servers 102. The user profile may include a picture of the user 110, and as such, is considered user locating data utilized for micro-location.

A driver (or an autonomous vehicle) receives a request for a ride from the user 110 via an application installed on a mobile device inside the vehicle 106. It should be understood that such an application may be integrated into the system of the vehicle 106. Generally, the driver (not shown) accepts the ride request from the user 110 and is directed to a general location of the user 110 (e.g., via GPS or other navigation means). When the vehicle 106 arrives at a general location of the user 110 that requested the ride, the driver (or the vehicle) may not be able to recognize the user 110, and/or the user 110 may not be able to identify the vehicle 106. Accordingly, the vehicle 106 and/or the user 110 are configured with identifying instrumentation. For example, the vehicle 106 is equipped with a sensor pack coupled to a computing device. In FIG. 1, the sensor pack includes a video camera 108 (e.g., a 360-degree RGB or infrared camera), but other types of sensors are contemplated. For example, the sensor pack may include microphones, antennas, etc. The sensor pack (e.g., the video camera 108) includes or is communicatively coupled to means for communicating over the communication network 104. Such communication may be implemented via a networked device. The sensor pack is configured to sense data sourced from the physical proximity of the vehicle. Thus, audio, visual, and signal data is sourced from an environment around the vehicle 106. In this context, “sourced” means that the basis of the data is within a physical proximity of the vehicle 106.

When the vehicle 106 arrives at a general location of the user 110, the sensor pack (e.g., the video camera 108) is activated and begins capturing locating data such as image data. The activation may be based on, for example, when the vehicle 106 (or a mobile device within the vehicle) detects that the vehicle 106 is within a certain range of the user 110 based on GPS data received via the initial ride request. The activation range may correspond to a proximity condition. In some example implementations, faces of bystanders (e.g., the bystander 112) are captured by the video camera 108 and transmitted to the micro-location servers 102. In other implementations, video data (including the bystander footage) is transmitted to the micro-location servers 102. Thus, the video camera 108 may be implemented with pattern recognition features, or such pattern recognition is performed in the micro-location servers 102.

The micro-location servers 102 analyze the video data (or identified faces) with reference to the identifying data to determine whether the data satisfies a location matching condition. In some example implementations, the location matching condition is satisfied when a face from data captured via the video camera 108 matches the identifying data (e.g., the picture of the user 110). Thus, as the vehicle moves down a road, the micro-location servers 102 compare faces of bystanders (e.g., the locating data received from the vehicle 106) to the face of the user to determine whether a match exists. As noted above, because the signal data is sourced within the physical proximity of the vehicle 106, satisfaction of the location matching condition signals that the first entity is “within” that detectable (by the sensors) physical proximity of the entity.

When the location matching condition is satisfied, the micro-location server 102 may generate a location refining signal and transmit the location refining signal to the vehicle 106 and/or the user 110. For example, the location refining signal may alert a navigation system (e.g., mobile device, GPS device, integrated device) within the vehicle 106 to display the location of the matched user. The alert may be displayed visually (e.g., with direction/distance identifiers on a display screen), audibly (e.g., direction and distance), tactilely (e.g., increased vibration as the vehicle nears the user 110), etc. The location refining signal may further alert the user 110 (e.g., via the mobile device 114) that the vehicle is approaching and may alert the user using feedback as described with respect to the vehicle 106. Thus, the locating data from the vehicle 106 and the locating data from the user 110 are used to locate each of the user 110 and the vehicle 106 with each other.

In some example implementations, the user 110 captures locating data using the mobile device 114 (e.g., mobile device camera) while the vehicle is approaching. Such capturing may occur responsive to the vehicle being within a range of the user 110 (e.g., based on GPS data). Furthermore, the micro-location server 102 may store image data of the vehicle 106 (e.g., color, shape, type) and other identifying data (e.g., car tag number). The locating data may be transmitted to the micro-location servers 102 via the communication network 104 where the micro-location servers 102 compare the data received from the mobile device 114 of the user 110 with the image data of the vehicle 106 to determine whether the data satisfies the location matching condition. Thus, the mobile device 114 may capture the tag of the vehicle 116, which does not satisfy the location matching condition (e.g., does not match the vehicle identifying data received from the vehicle 106). When the data satisfies a location matching condition (e.g., the vehicle 106 is identified in the data received from the mobile device 114), the micro-location servers 102 generate a location refining signal as described above.

Similarly, the vehicle 106 may emit a signal of some sort when the vehicle 106 satisfies the proximity condition based on the distance between the user 110 and the vehicle 106. One example signal that the vehicle may emit is a light flashing pattern via the headlights of the vehicle. Accordingly, locating data of the vehicle is the vehicle identifying data (e.g., the headlight flashing pattern), and the locating data of the mobile device is visual data (e.g., video data). The micro-location servers 102 determine whether the visual data captured by the mobile device 114 includes the light pattern (the vehicle identifying data) to determine whether the location matching condition is satisfied. Similarly, the vehicle 106 may emit a Wi-Fi signal or other wireless signal as vehicle identifying data that may be detectable by the mobile device 114, which may be utilized to determine whether the location matching condition is satisfied. It should be understood that the mobile device 114 may also emit a signal (light pattern or wireless signal) that is detectable by the sensor pack (e.g., the video camera 108) of the vehicle 106. Such signals may also be used for the location refining signal. Other data that may be used as locating data includes LoRa, chirp protocol, depth map, sonar, LIDAR, radar, QR or other identifying markers, inertial measurement unit data, etc. Such data may be collected by a mobile device, a vehicle with sensors, or other means.

In some example implementations, the determination of whether the location matching condition is satisfied is processed on the mobile device 114 and/or in the vehicle 106 instead of the micro-location servers 102. Thus, if the mobile device 114 is processing the determination, identifying information (e.g., locating data such as real-time video or vehicle identifying data) may be transmitted to the mobile device 114 where the mobile device 114 compares the locating data received from the vehicle 106 with the locating data captured by the mobile device 114. Similarly, the vehicle 106 may receive locating data from the mobile device 114, and computing systems within the vehicle 106 determine whether the locating data received from the mobile device 114 and the locating data stored on or captured by the vehicle (e.g., the video camera 108) satisfy the location matching condition.

In some example implementations, locating data received from the mobile device 114 include background data such as background image data. For example, the user 110 may capture video and or still image data of the surroundings of the user 110. The surroundings may include buildings, lights, signage, structures, etc. The vehicle 106 captures similar data, and the micro-location servers 102 perform pattern recognition techniques on the locating data received from the mobile device 114 and the locating data received from the vehicle 106 to determine whether the vehicle 106 and the user 110 are in the same or a similar proximity, and thus, whether the location matching condition is satisfied.

In another example implementation, the locating data captured by the vehicle 106 and the mobile device 114 includes audio data captured by audio sensing devices such as a microphone. The audio data received from the user 110 and the audio data received from the vehicle are compared to determine whether the user 110 and the vehicle 106 are in the same or similar proximities. The audio data may include ambient audio data of the environments for the vehicle 106 and the user 110. Audio comparison and processing techniques such as sound localization and sound fingerprinting may be performed by the micro-location servers 102 to identify patterns and to determine whether the data satisfy the location matching condition based on matching patterns.

In yet another example implementation, locating data detected by the vehicle 106 and the mobile device 114 includes received wireless signal data. For example, the mobile device 114 may be in the proximity of one or more Wi-Fi signals detectable by one or more antenna of the mobile device 114. The mobile device transmits an identification of the one or more signals to the micro-location servers 102. As the vehicle 106 travels within a general location of the user 110, one or more antennas of the vehicle detect Wi-Fi signals, and the vehicle transmits identification of detected signals to the micro-location servers 102. When the detected signals of the mobile device 114 and the detected signals of the vehicle 106 are the same or similar (e.g., overlapping), the location matching condition is satisfied, and a location refining signal is generated and transmitted to the vehicle 106 and/or the mobile device 114. It should be understood that the signal detection methods may be utilized with different protocols other than Wi-Fi, including, without limitation, cellular signals, Bluetooth signals, beacon signals, and other radiofrequency (RF) signals. Furthermore, one or both of the entities (the mobile device 114 and the vehicle 106) and/or the micro-location servers 102 may utilize detected signals for determining locations using triangulation methods.

When comparing the various locating data from the mobile device 114 and the vehicle 106, the micro-location servers 102 (or computing systems in the vehicle 106 or the mobile device 114) perform pattern recognition techniques to determine whether the data satisfy the location matching condition. In the genre of facial recognition, pattern recognition techniques include, without limitation, landmark recognition, 3-dimensional recognition, skin texture analysis, thermal recognition. It should be understood that other methods of geo-location are contemplated.

It should be understood that the implementations described herein are applicable to scenarios other than a vehicle/passenger scenario. For example, the implementations described may be useful in a search and rescuer scenario wherein a searcher and the lost or distressed person transmit locating data, and the locating data is utilized to co-locate the searcher and lost or distressed person. Sensor devices may be attached to a mechanism of the searcher (e.g., camera attached to a helicopter) and/or mobile or handheld devices may be utilized. In another example scenario, two users may utilize mobile devices to locate one another in a crowded place, such as a theme park. The two users may utilize the mobile devices to transmit locating data, which is utilized to determine whether the location matching condition is satisfied. Other scenarios are contemplated.

The implementations described herein improve location systems, methods, and processed by a utilizing at least some real-time sensor data that is detected from a physical proximity of at least one of the entities. Thus, systems that rely on high granularity location systems to locate entities within a general location may be improved using the implementations described herein by incorporating some locale data within the physical proximity of the entities. Furthermore, to save processing resources (e.g., battery and processor resources), the sensors may be activated when the entities are within a certain range (e.g., proximity condition) rather than running such implementations full time.

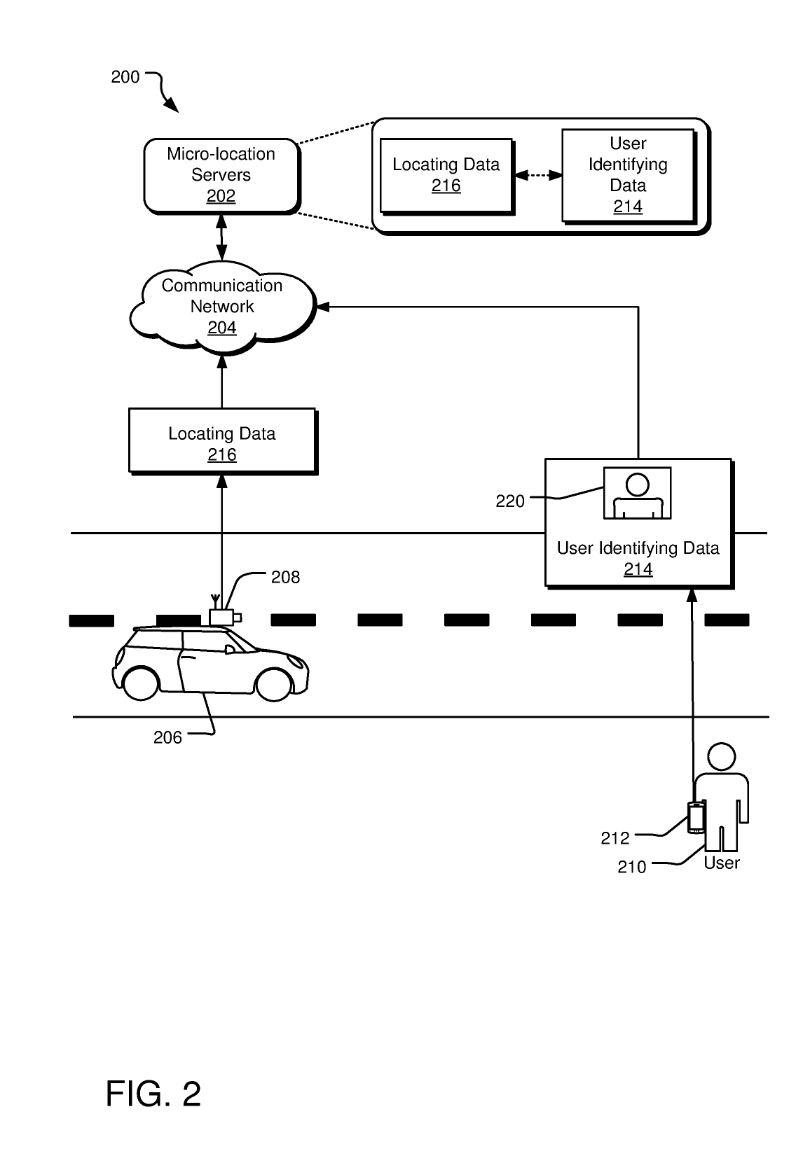

FIG. 2 illustrates another example environment 200 for mobile micro-location. The environment 200 includes micro-location servers 202, a communication network 204, a vehicle 206 with a sensor pack 208, and a user 210 with a mobile device 212. The user 210 has requested a vehicle using an application installed on the mobile device, for example. In the illustrated implementation, the user 210 transmits user identifying data 214 as locating data to the micro-location servers 202, and the user identifying data 214 includes a picture 220 of the user 210. It should be understood that other locating data for the user 210 may be included with the user identifying data transmitted to the micro-location servers 202. For example, locating data such as image data of the surroundings of the user 210, sound data of ambient noise near the user 210, and video data captured by the mobile device may be transmitted to the micro-location servers 202.

The vehicle 206 accepts the request from the user 210. For example, a driver (not shown) of the vehicle may accept the request via an application installed on a mobile application in the vehicle 206. In another example implementation, the vehicle 206 is an autonomous vehicle that accepts the ride request from the user 210. In some example implementations, the vehicle 206 is navigated (via a driver with GPS or automatically via GPS) to a general location of the user. In the illustrated example, when the vehicle 206 is within a certain distance to the user 210 (e.g., based on GPS data received with the user identifying data 214), the vehicle 206 activates the sensor pack 208. The sensor pack 208 captures locating data 216, which is transmitted to the micro-location servers 202 via the communication network 204.

The micro-location servers 202 receive the user identifying data 214 from the mobile device 212 of the user 210 and receive the locating data 216 from the vehicle 206. The micro-location servers 202 analyze the received data to determine whether the received data satisfies a location matching condition. Such analysis may include pattern recognition techniques, sound recognition techniques, facial recognition techniques, image recognition techniques, optical character recognition (e.g., to identify letters/numbers on license plates and/or signs) to determine whether the location matching condition is satisfied. In the illustrated implementation, the picture 220 may be compared to the locating data 216 (e.g., image data) to determine whether a match exists in the video data. Satisfaction of the location matching condition signals that the user 210 (a first entity) and the vehicle 206 (a second entity) are in the same or a similar physical proximity. It should be understood that visual data includes video data and still image data. Responsive to determining that the location matching condition is satisfied, the micro-location servers 202 generate a location refining signal that is transmitted to the vehicle 206 and/or the user 210. The location refining signal may be utilized by the user and/or the vehicle 206 to provide further guidance to the user 210 and/or the vehicle 206 to identify one another.

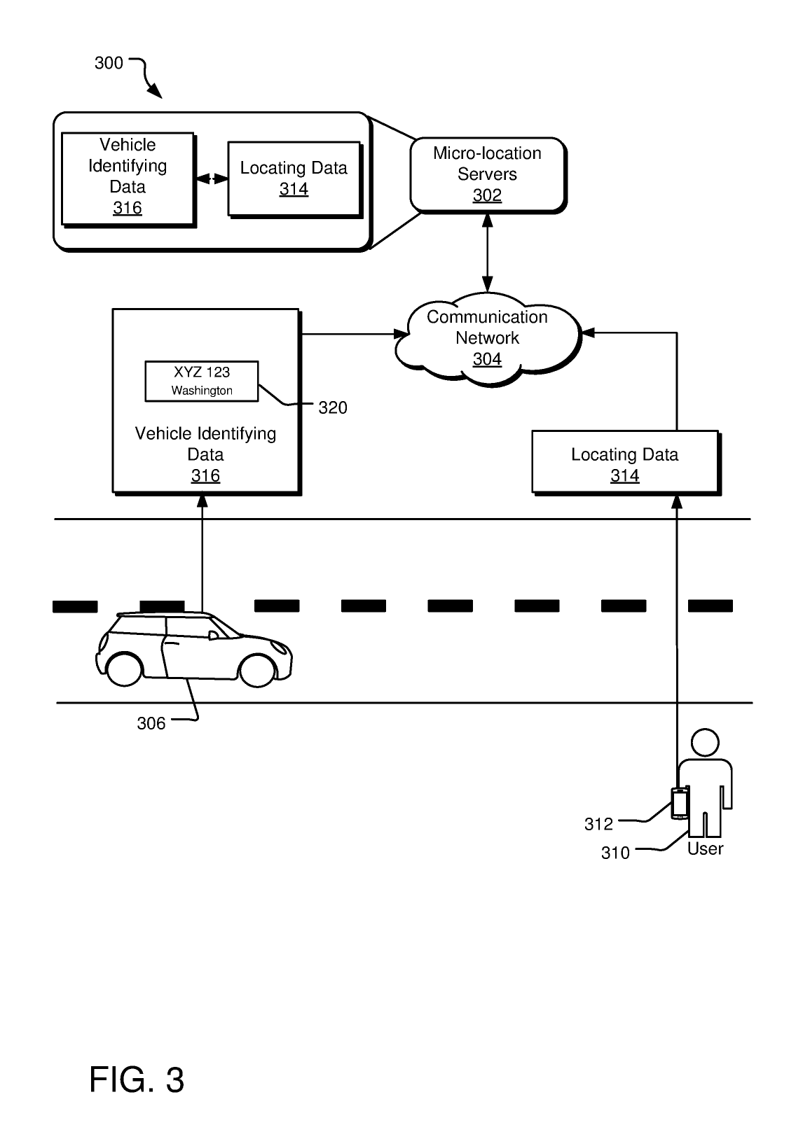

FIG. 3 illustrates another example environment 300 for mobile micro-location. The environment 300 includes micro-location servers 302, a communication network 304, a vehicle 306, and a user 310 with a mobile device 312. The user 310 has requested a vehicle using an application installed on the mobile device, for example. The vehicle 306 accepts the request from the user 310. For example, a driver (not shown) of the vehicle may accept the request via an application installed on a mobile application in the vehicle 306. In another example implementation, the vehicle 306 is an autonomous vehicle that accepts the ride request from the user 310. Vehicle identifying data 316 is transmitted to (or previously stored on) the micro-location servers 302. In the illustrated example, the vehicle identifying data 316 includes vehicle identifying characteristics such as license plate data 320. The license plate data 320 may be image data of the license plate mounted to the vehicle 306 or an identification of the characters of the license plate. Other vehicle identifying characteristics may include vehicle make, model, and color.

In some example implementations, the vehicle 306 is navigated (via a driver with GPS or automatically via GPS) to a general location of the user 310. In the illustrated example, when the vehicle 306 is within a certain distance to the user 310 (e.g., based on GPS data received with the locating data 314), the user 310 is alerted by the mobile device 312 to the vehicle 306 being within the proximity of the user 310 and is instructed to activate locating data sensing. In the illustrated implementation, a camera of the mobile device 312 is activated. In some implementations, the locating data sensing is automatically activated when the two entities are in the same proximity (e.g., satisfy a proximity condition). The camera captures live video data of the surroundings of the user 310 including any vehicles that may be within the proximity of the user 310. The camera may automatically detect license plates of vehicles within the proximity, or the video data is transmitted to the micro-location servers 302 where licenses plates are identified using pattern matching/optical character recognition techniques. The micro-locations servers 302 compare vehicle identifying data and locating data 318 received from the mobile device 312 to determine whether the location matching condition is satisfied.

Satisfaction of the location matching condition signals that the user 310 (a first entity) and the vehicle 306 (a second entity) are in the same or a similar proximity. Responsive to determining that the location matching condition is satisfied, the micro-location servers 302 generate a location refining signal that is transmitted to the vehicle 306 and/or the user 310. The location refining signal may be utilized by the user and/or the vehicle 306 to provide further guidance to the user 310 and/or the vehicle 306 to identify one another.

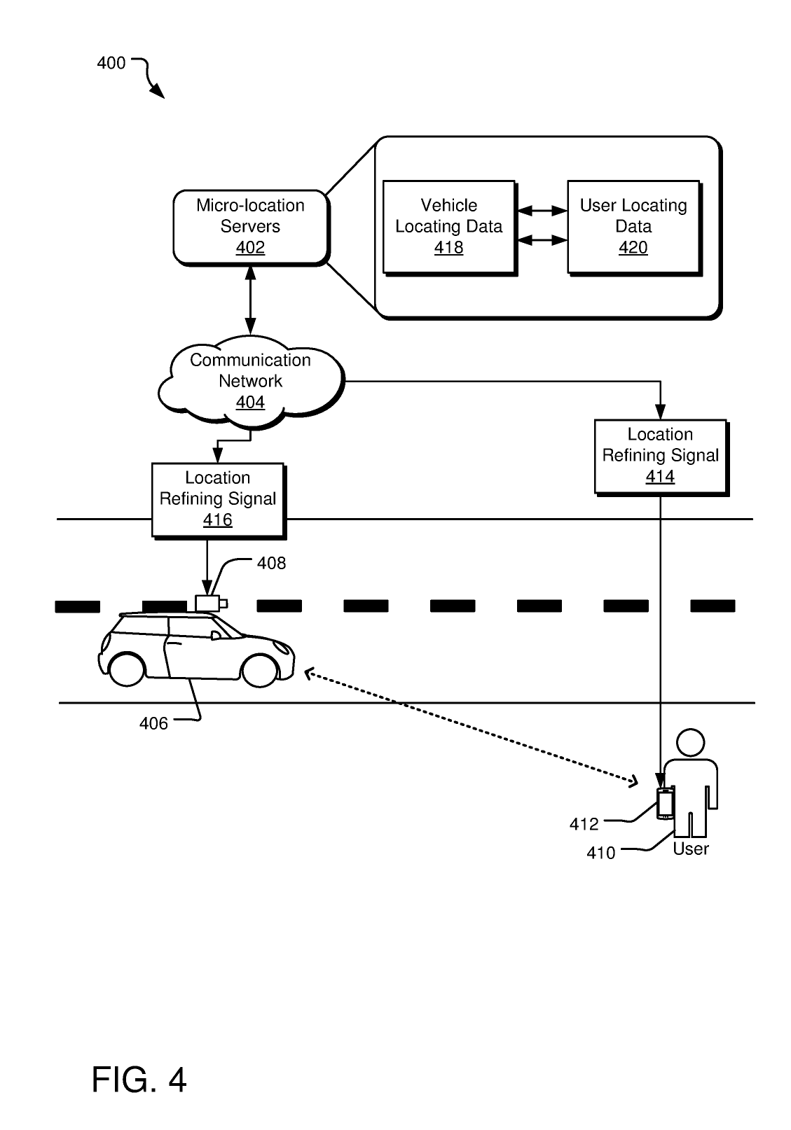

FIG. 4 illustrates another example environment 400 for mobile micro-location. The environment 400 includes micro-location servers 402, a communication network 404, a vehicle 406 with a sensor pack 408, and a user 410 with a mobile device 412. In FIG. 4, the user 410 has requested a ride, and the vehicle 406 (or the driver of the vehicle) has accepted the ride request. The vehicle 406 navigated to a general location of the user 410, and the micro-location servers 402 received vehicle locating data 418 from the vehicle 406, and user locating data 420 from the mobile device 412 of the user 410 and analyzed the received data to determine whether the data satisfied a location matching condition. The vehicle locating data 418 may include, without limitation, vehicle identifying data such as license plate data, vehicle type and characteristics, video data, audio data, signal data, etc. The user locating data 420 may include, without limitation, user identifying data such as image data, video data, audio data, signal data, etc. The micro-location servers 402 determined that some of the data satisfy the location matching condition, which signals that the vehicle 406 is in a similar or the same proximity of the user 410.

Responsive to determining that the vehicle locating data 418 and the user locating data 420 satisfies the location matching condition, the micro-location servers 402 generates location refining signals 414 and 416, which are transmitted to the mobile device 412 of the user 410 and the vehicle 406, respectively. The location refining signals 414 and 416 guide the user 410 and the vehicle 406 to each other. For example, the location refining signal 414 transmitted to the mobile device 412 of the user may include instructions for the mobile device 412 to display an arrow pointing to the vehicle 406 and a contemporaneous distance between the mobile device 412 and the vehicle 406 as determined based on the locating data. In another example implementation, the location refining signal 414 transmitted to the mobile device 412 of the user 410 may include instructions that cause the device to vibrate as the vehicle approaches. The location refining signal 416 transmitted to the vehicle 406 may operate similarly to the location refining signal 414. Other types of feedback that may be triggered responsive by a location refining signal include haptics, spatial audio, 3D holograms, etc.

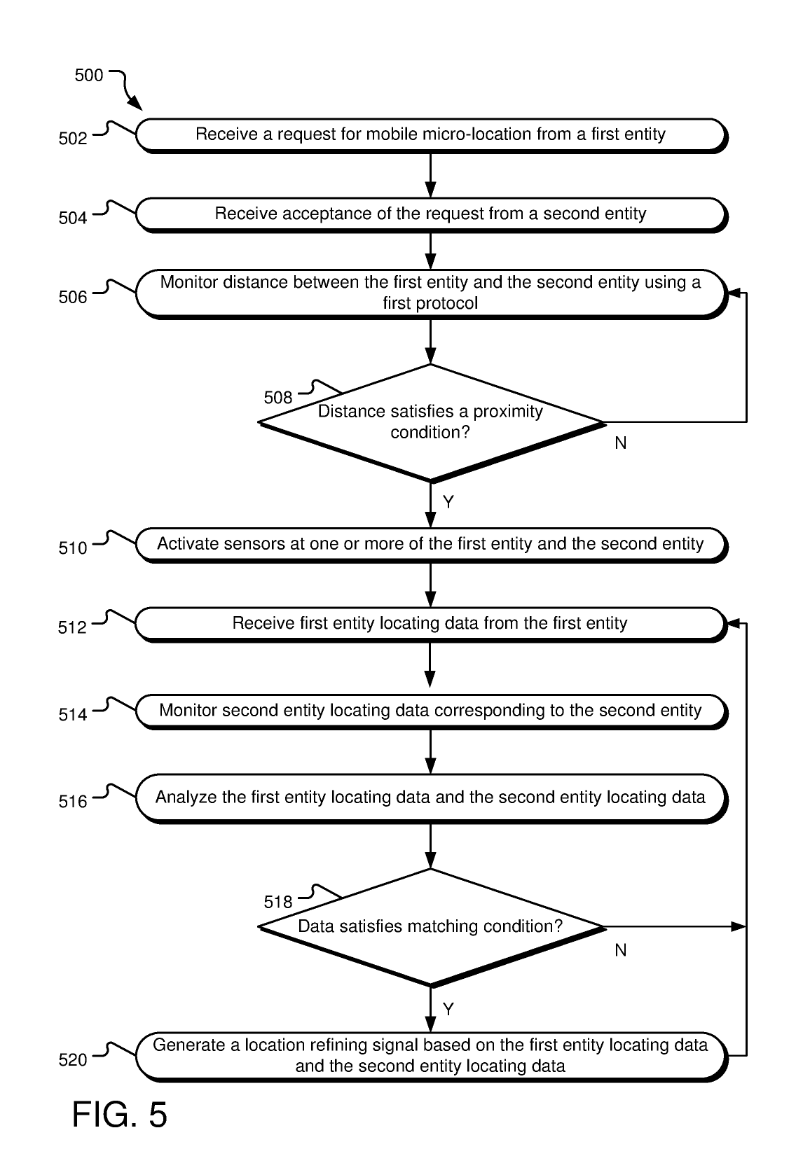

FIG. 5 illustrates example location operations 500. A receiving operation 502 receives a request for mobile micro-location from a first entity. The receiving operation 502 may be received at a micro-location server or at a second entity. A receiving operation 504 receives acceptance of the request from a second entity. For example, in a scenario where the first entity is a requesting passenger and the second entity is a vehicle/driver, the first entity requests a pickup at a general location. The driver/car accepts the request and begins navigating to the general location. A monitoring operation 506 monitors a distance between the first entity and the second entity using a first protocol. For example, the monitoring operation 506 may monitor GPS data of the first entity and the second entity to determine the distance. A determining operation 508 determines whether the distance satisfies a proximity condition. The proximity condition may be based on, a distance threshold such as 100 yards, 1 mile, etc. If the proximity condition is not satisfied, then the process returns to the monitoring operation 506 that monitors the distance between the first entity and the second entity using the first protocol.

If the proximity condition is satisfied, then an activating operation 510 activates sensors connected to (or integrated into) a computing device at one or more of the first entity and the second entity. A receiving operation 512 receives first entity locating data from the first entity. The first entity locating data may be identifying data of the first entity (e.g., a picture), environment image data, audio data, etc. The first entity locating data may be previously stored (e.g., profile data) or be detected in a real-time manner (e.g., a current picture) by one or more sensors. Profile data may be stored in a database as a graph associated with the user. Similar identifying data may be stored as a graph and is associated with other entities such as vehicles, autonomous entities, etc. A monitoring operation 514 monitors second entity locating data corresponding to the second entity. The second entity locating data may be video data, image data, audio data, signal data, etc. detected by one or more sensors connected to the second entity. An analyzing operation 516 analyzes the first entity locating data and the second entity locating data. A determining operation 518 determines whether the data (the first entity locating data and the second entity locating data) satisfies a location matching condition. Satisfaction of the location matching condition may be based on, for example, facial recognition techniques recognizing user identifying data (e.g., first entity locating data) in the second entity locating data. Other recognition techniques may include geo-location using signal data, sound data, video data, image data, etc. The location matching condition may be dependent on the signal data detectable by the one or more sensors. Thus, the data generated by the one or more sensors is sourced from a physical proximity of the sensors (and thus the entity). In other words, the audio data, visual data, signal data, etc. may be sourced from the physical surroundings (proximity) of the entity utilizing the one or more sensors for location. If the location matching condition is not satisfied, then the process returns to the receiving operation 512, which receives the first entity locating data from the first entity, and the monitoring operation 514, which monitors second entity locating data corresponding to the second entity. In some example implementations, first entity locating data is not received again. For example, if the first entity locating data is user identifying data (e.g., the image of the user) or vehicle identifying data (e.g., vehicle tag information or vehicle characteristics), then such information may not be transmitted/received again because it is unchanging and, therefore, unnecessary to update.

If the location matching condition is satisfied, then a generating operation 520 generates a location refining signal based on the first entity locating data and the second entity locating data. The process may return to the receiving operation 512, which receives the first entity locating data. As noted above, the first entity locating data may not be received again, but the monitoring operation 514 monitors the second entity locating data corresponding to the second entity. Such data may be further analyzed in the analyzing operation 516, and the location matching condition may be checked again. The location refining signal may be further refined (e.g., distance/direction updated). Thus, the receiving operation, the monitoring operation 514, the analyzing operation, the determining operation 518, and the generating operation 520 may form a continuous or intermittent process.

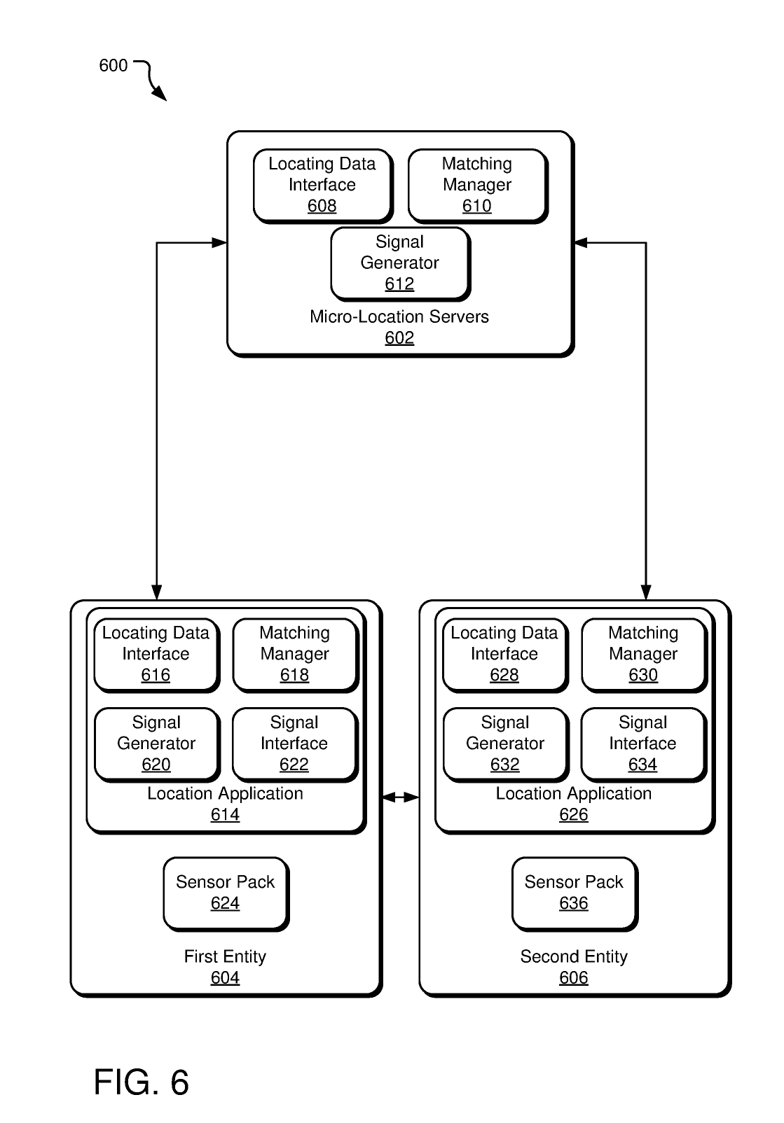

FIG. 6 illustrates a block diagram 600 of example system utilized for mobile micro-location. The block diagram includes micro-location servers 602, a first entity 604, and a second entity 606. The first entity 604 and the second entity 606 may be a part of a vehicle (autonomous or human operated), smart device, etc. that may be utilized for locating. Example vehicles that may include or be connected to the first entity 604 include road vehicles (e.g., cars, buses, SUVs), aquatic vehicles, aviation vehicles, land-based drones, aviation drones, aquatic drones, etc. The implementations described herein may be applicable to situations wherein the first entity 604 is associated with a vehicle and the second entity 606 is associated with a passenger or user, wherein the first entity 604 is associated with a vehicle and the second entity 606 is associated with a vehicle, and wherein the first entity 604 is associated with a user and the second entity 606 is associated with a user.

The micro-location servers 602 may be cloud-based servers that are separated in different geographical locations or in the same or similar locations. The micro-location servers 602 include facilities for receiving requests, receiving data, delivering data, and facilitating communication between two entities (e.g., the first entity 604 and the second entity 606). The micro-location servers 602 may be associated with a specific location application or may support many location applications that are installed on client-side devices or systems. The micro-location servers 602 include a locating data interface 608 for receiving locating data from one or more entities (e.g., the first entity 604 and the second entity 606). The micro-location servers 602 further include a matching manager 610 communicatively coupled to the locating data interface 608. The matching manager 610 is configured to determine whether the received locating data satisfies a location matching condition. The matching manager 610 is operable to perform facial recognition processes, image recognition processes, optical character recognition processes, sound matching processes, signal matching processes, and other machine learning or pattern recognition processes for determining whether the location matching condition may be satisfied. The micro-location servers 602 further includes a signal generator 612 that is operable to generate a location refining signal that is transmitted to one or more entities. The location refining signal may include locating data received from one or more of the entities, instructions for guidance through a user interface of one or more of the entities, instructions for further locating one or more of the entities, etc.

The first entity 604 and the second entity 606 include facilities for detecting locating data, location applications, signal facilities, etc. For example, the first entity 604 includes a sensor pack 624, which may include one or more cameras, microphones, antennas, etc. The first entity 604 includes a location application 614 that includes a locating data interface 616 that may receive locating data from another entity (e.g., the second entity 606) or the micro-location servers 602 and send data to another entity or to the micro-location servers 602. In some example implementations, one of the entities determines whether the location matching condition is satisfied. Thus, the first entity 604 may include a matching manager 618, which may include similar functionality as those described above with respect to the matching manager 610 of the micro-location servers 602. The first entity 604 may further include a signal generator 620 for generating a location refining signal and a signal interface 622 for receiving a location refining signal from the micro-location servers 602 and/or the second entity 606. Similarly, the second entity 606 may include a sensor pack 636 and a location application 626. The location application 626 may include a locating data interface 628 (for sending/receiving locating data), a matching manager 630 (for checking the location matching condition), a signal generator 632 (for generating a location refining signal), and a signal interface 634 (for sending/receiving location refining signals).

In some example implementations, refining location by two entities is achieved using different packs or stages of sensors. For example, GPS is initially used to direct the two entities within a general location (e.g., within a first proximity defined by a first distance). After the two entities are within the first proximity, a second sensor pack may be activated at one or both of the entities. For example, after GPS directs the entities within a general location, facial recognition sensors (e.g., cameras) are activated and utilized to locate to another proximity (e.g., a second proximity condition defined by a second smaller distance). A third sensor pack may be activated for even smaller distances (e.g., millimeter and sub-millimeter). Such a process may be useful wherein the two entities are autonomous mechanisms (e.g., robots) that are docking with one another.

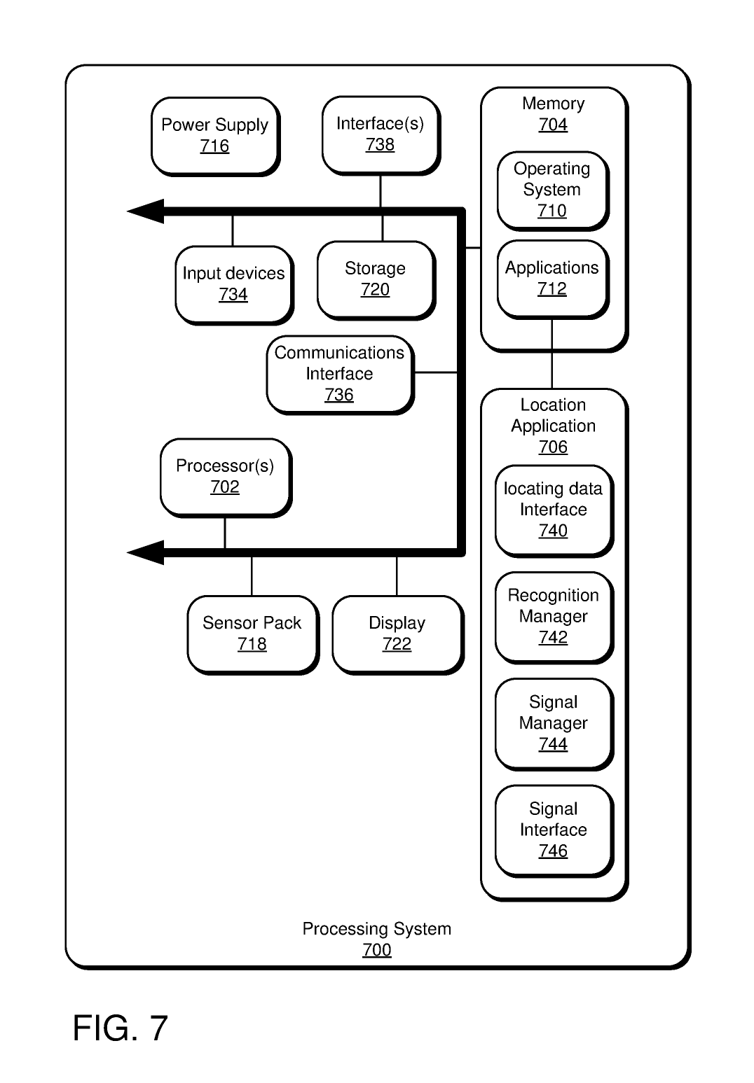

FIG. 7 illustrates an example system (labeled as a processing system 700) that may be useful in implementing the described technology. The processing system may be a client device such as a laptop, mobile device, desktop, tablet, or a server/cloud device. The processing system 700 includes one or more processor(s) 702, and a memory 704. The memory 704 generally includes both volatile memory (e.g., RAM) and non-volatile memory (e.g., flash memory). An operating system 710 resides in the memory 704 and is executed by the processor(s) 702.

One or more application programs 712 modules or segments, such as a location application 706 are loaded in the memory 704 and/or the storage 720 and executed by the processor(s) 702. The location application 706 may include a locating data interface 740, a recognition manager 742, a signal generator 744, or a signal interface 746, which may be stored in the memory 704 and/or the storage 720 and executed by the processor(s) 702. Data such as user data, location data, distance data, condition data, vehicle data, sensor data, etc. may be stored in the memory 704, or the storage 720 and may be retrievable by the processor(s) 702 for use in micro-location by the location application 706 or other applications. The storage 720 may be local to the processing system 700 or may be remote and communicatively connected to the processing system 700 and may include another server. The storage 720 may store resources that are requestable by client devices (not shown).

The processing system 700 includes a power supply 716, which is powered by one or more batteries or other power sources and which provides power to other components of the processing system 700. The power supply 716 may also be connected to an external power source that overrides or recharges the built-in batteries or other power sources.

The processing system 700 may include one or more communications interface 736 to provide network and device connectivity (e.g., mobile phone network, Wi-Fi®, Bluetooth®, etc.) to one or more other servers and/or client devices/entities (e.g., mobile devices, desktop computers, or laptop computers, USB devices). The processing system 700 may use the communications interface 736 and any other types of communication devices for establishing connections over a wide-area network (WAN) or local-area network (LAN). It should be appreciated that the network connections shown are exemplary and that other communications devices and means for establishing a communications link between the processing system 700 and other devices may be used.

The processing system 700 may include one or more input devices 734 such that a user may enter commands and information (e.g., a keyboard or mouse). These and other input devices may be coupled to the server by one or more interfaces 738 such as a serial port interface, parallel port, universal serial bus (USB), etc. The processing system 700 may further include a display 722 such as a touchscreen display. The processing system 700 may further include a sensor pack 718, which includes one or more sensors that detect locating data such as identifying data, environment data, sound data, image/video data, signal data, etc.

The processing system 700 may include a variety of tangible processor-readable storage media and intangible processor-readable communication signals. Tangible processor-readable storage can be embodied by any available media that can be accessed by the processing system 700 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing system 700. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

An example system for locating a first entity by a second entity using one or more sensors coupled to at least one computing device described herein includes a locating data interface configured to monitor second entity locating data corresponding to the second entity. At least some of the second entity locating data is derived from a physical proximity of the second entity by the one or more sensors coupled to the at least one computing device. The example system further includes a matching manager communicatively coupled to the locating data interface and configured to receive first entity locating data and to determine whether the first entity locating data and the second entity locating data satisfy a location matching condition. Satisfaction of the location matching condition indicates that the first entity is located within the physical proximity detectable by the one or more sensors coupled to the at least one computing device. The system further includes a signal generator communicatively coupled to the matching manager and configured to generate a location refining signal based on the first entity locating data and the second entity locating data responsive to the first entity locating data and the second entity locating data satisfying the location matching condition. The locating providing signal provides guidance to at least one of the first entity and the second entity.

Another example system of any preceding system comprises the first entity locating data including visual data of physical surroundings of the first entity, the second entity locating data including visual data generated by the one or more sensors coupled to the at least one computing device, and the location matching condition being satisfied responsive to the matching manager identifying the physical surroundings in the second entity locating data based on the visual data.

Another example system of any preceding system comprises the first entity locating data including visual data of a user associated with the first entity, the second entity locating data including visual data generated by the one or more sensors coupled to the at least one computing device, and the location matching condition being satisfied responsive to the matching manager identifying the user associated with the first entity in the visual data generated by the one or more sensors coupled to the at least one computing device. The user is identified using facial recognition techniques.

Another example system of any preceding system comprises the first entity being associated with a vehicle, the first entity locating data including vehicle identifying characteristics, the second entity locating data including visual data captured by a camera of a mobile device, and the location matching condition being satisfied responsive to the matching manager identifying the vehicle identifying characteristics in the visual data captured by the camera of the mobile device.

Another example system of any preceding system comprises the first entity locating data including audio data of surroundings detectable by a computing device associated with the first entity, the second entity locating data including audio data generated by the one or more sensors coupled to the at least one computing device, and the location matching condition being satisfied responsive to the matching manager identifying matching patterns in the audio data of surroundings detectable by the computing device associated with the first entity and the audio data generated by the one or more sensors coupled to the at least one computing device.

Another example system of any preceding system comprises the location refining signal including contemporaneous distance separation data corresponding to a distance between the second entity and the first entity as determined based on the second entity locating data and the first entity locating data.

An example method for locating a first entity by a second entity using one or more sensors coupled to at least one computing device described herein comprises monitoring second entity locating data corresponding to the second entity. At least some of the second entity locating data is derived from a physical proximity of the second entity by the one or more sensors coupled to the at least one computing device. The method further comprises analyzing the monitored second entity locating data and received first entity locating data corresponding the first entity to determine whether the first entity locating data and the second entity locating data satisfy a location matching condition. Satisfaction of the location matching condition indicates that the first entity is located within the physical proximity detectable by the one or more sensors coupled to the at least one computing device. The method further comprises generating a location refining signal based on the second entity locating data and the first entity locating data responsive to the second entity locating data and the first entity locating data satisfying the location matching condition. The location refining signal provides guidance to at least one of the second entity and the first entity.

Another example method of any preceding method comprises the first entity locating data including visual data of physical surroundings of the first entity, the second entity locating data including visual data generated by the one or more sensors coupled to the at least one computing device, and the location matching condition being satisfied responsive to identifying the physical surroundings in the second entity locating data based on the visual data of the physical surroundings of the first entity.

Another example method of any preceding method comprises the first entity locating data including visual data of a user associated with the first entity, the second entity locating data including visual data generated by the one or more sensors coupled to the at least one computing device, and the location matching condition being satisfied responsive to identifying the user associated with the first entity in the visual data generated by the one or more sensors coupled to the at least one computing device. The user is identified using facial recognition techniques.

Another example method of any preceding method comprises the first entity being associated with a vehicle, the first entity locating data including vehicle identifying characteristics, the second entity locating data including visual data captured by a camera of a mobile device, and the location matching condition being satisfied responsive to identifying the vehicle identifying characteristics in the visual data captured by the camera of the mobile device.

Another example method of any preceding method comprises the first entity locating data including audio data of surroundings detectable by a computing device associated with the first entity, the second entity locating data including audio data generated by the one or more sensors coupled to the at least one computing device, and the location matching condition being satisfied responsive to identifying matching patterns in the audio data of surroundings detectable by the computing device associated with the first entity and the audio data generated by the one or more sensors coupled to the at least one computing device.

Another example method of any preceding method comprises the location refining signal including contemporaneous distance separation data corresponding to a distance between the second entity and the first entity as determined based on the second entity locating data and the first entity locating data.

Another example method of any preceding method comprises the one or more sensors coupled to the at least one computing device being activated responsive to detection of satisfaction of a proximity condition based on a distance between the first entity and the second entity.

One or more example tangible processor-readable storage media embodied with instructions for executing on one or more processors and circuits of a device an example process for locating a first entity by a second entity using one or more sensors coupled to at least one computing device comprises monitoring second entity locating data corresponding to the second entity. At least some of the second entity locating data is derived from a physical proximity of the second entity by the one or more sensors coupled to the at least one computing device. The process further comprises analyzing the monitored second entity locating data and received first entity locating data corresponding the first entity to determine whether the first entity locating data and the second entity locating data satisfy a location matching condition. Satisfaction of the location matching condition indicates that the first entity is located within the physical proximity detectable by the one or more sensors coupled to the at least one computing device. The process further comprises generating a location refining signal based on the second entity locating data and the first entity locating data responsive to the second entity locating data and the first entity locating data satisfying the location matching condition. The location refining signal provides guidance to at least one of the second entity and the first entity.

Another example process of any preceding process comprises the first entity locating data including visual data of physical surroundings of the first entity, the second entity locating data including visual data generated by the one or more sensors coupled to the at least one computing device, and the location matching condition being satisfied responsive to identifying the physical surroundings in the second entity locating data based on the visual data.

Another example process of any preceding process comprises the first entity locating data including visual data of a user associated with the first entity, the second entity locating data including visual data generated by the one or more sensors coupled to the at least one computing device, and the location matching condition being satisfied responsive to identifying the user associated with the first entity in the visual data generated by the one or more sensors coupled to the at least one computing device. The user is identified using facial recognition techniques.

Another example process of any preceding process comprises the first entity being associated with a vehicle, the first entity locating data including vehicle identifying characteristics, the second entity locating data including visual data captured by a camera of a mobile device, and the location matching condition being satisfied responsive to identifying the vehicle identifying characteristics in the visual data captured by the camera of the mobile device.

Another example process of any preceding process comprises the first entity locating data including audio data of surroundings detectable by a computing device associated with the first entity, the second entity locating data including audio data generated by the one or more sensors coupled to the at least one computing device, and the location matching condition being satisfied responsive to identifying matching patterns in the audio data of surroundings detectable by the computing device associated with the first entity and the audio data generated by the one or more sensors coupled to the at least one computing device.

Another example process of any preceding process comprises the first entity locating data including signal data of wireless signals detected by a computing device associated with the first entity, the second entity locating data including signal data detected by the one or more sensors coupled to the at least one computing device, and the location matching condition being satisfied responsive to identifying matching patterns between the signal data of the wireless signals detected by the computing device associated with the first entity and the signal data detected by the one or more sensors coupled to the at least one computing device.

Another example process of any preceding process comprises the one or more sensors coupled to the at least one computing device being activated responsive to detection of satisfaction of a proximity condition based on a distance between the first entity and the second entity.

An example system disclosed herein includes a means for locating a first entity by a second entity using one or more sensors coupled to at least one computing device. The system includes means for monitoring second entity locating data corresponding to the second entity. The system supports at least some of the second entity locating data being derived from a physical proximity of the second entity by the one or more sensors coupled to the at least one computing device. The system further includes means for analyzing the monitored second entity locating data and received first entity locating data corresponding the first entity to determine whether the first entity locating data and the second entity locating data satisfy a location matching condition. Satisfaction of the location matching condition indicates that the first entity is located within the physical proximity detectable by the one or more sensors coupled to the at least one computing device. The system further includes means for generating a location refining signal based on the second entity locating data and the first entity locating data responsive to the second entity locating data and the first entity locating data satisfying the location matching condition. The system supports the location refining signal providing guidance to at least one of the second entity and the first entity.

Another example system of any preceding system includes means for the first entity locating data to include visual data of physical surroundings of the first entity, the second entity locating data to include visual data generated by the one or more sensors coupled to the at least one computing device, and the location matching condition to be satisfied responsive to identifying the physical surroundings in the second entity locating data based on the visual data of the physical surroundings of the first entity.

Another example system of any preceding system includes means for the first entity locating data to include visual data of a user associated with the first entity, the second entity locating data to include visual data generated by the one or more sensors coupled to the at least one computing device, and the location matching condition to be satisfied responsive to identifying the user associated with the first entity in the visual data generated by the one or more sensors coupled to the at least one computing device. The system includes means for identifying the user using facial recognition techniques.

Another example system of any preceding system includes means for the first entity to be associated with a vehicle, the first entity locating data to include vehicle identifying characteristics, the second entity locating data to include visual data captured by a camera of a mobile device, and the location matching condition to be satisfied responsive to identifying the vehicle identifying characteristics in the visual data captured by the camera of the mobile device.

Another example system of any preceding system includes means for the first entity locating data to include audio data of surroundings detectable by a computing device associated with the first entity, the second entity locating data to include audio data generated by the one or more sensors coupled to the at least one computing device, and the location matching condition to be satisfied responsive to identifying matching patterns in the audio data of surroundings detectable by the computing device associated with the first entity and the audio data generated by the one or more sensors coupled to the at least one computing device.

Another example system of any preceding system includes means for the location refining signal to include contemporaneous distance separation data corresponding to a distance between the second entity and the first entity as determined based on the second entity locating data and the first entity locating data.

Another example system of any preceding system includes means for the one or more sensors coupled to the at least one computing device to be activated responsive to detection of satisfaction of a proximity condition based on a distance between the first entity and the second entity.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A system for locating a first entity by a second entity using one or more sensors coupled to at least one computing device comprising:
a locating data interface configured to monitor second entity locating data corresponding to the second entity, at least some of the second entity locating data being derived from a physical proximity of the second entity by the one or more sensors coupled to the at least one computing device;
a matching manager communicatively coupled to the locating data interface and configured to receive first entity locating data and to determine whether the first entity locating data and the second entity locating data satisfy a location matching condition, satisfaction of the location matching condition indicating that the first entity is located within the physical proximity detectable by the one or more sensors coupled to the at least one computing device; and
a signal generator communicatively coupled to the matching manager and configured to generate a location refining signal based on the first entity locating data and the second entity locating data responsive to the first entity locating data and the second entity locating data satisfying the location matching condition, the location refining signal providing guidance to at least one of the first entity and the second entity.

2. The system of claim 1 wherein the first entity locating data includes visual data of physical surroundings of the first entity, the second entity locating data includes visual data generated by the one or more sensors coupled to the at least one computing device, and the location matching condition is satisfied responsive to the matching manager identifying the physical surroundings in the second entity locating data based on the visual data.

3. The system of claim 1 wherein the first entity locating data includes visual data of a user associated with the first entity, the second entity locating data includes visual data generated by the one or more sensors coupled to the at least one computing device, and the location matching condition is satisfied responsive to the matching manager identifying the user associated with the first entity in the visual data generated by the one or more sensors coupled to the at least one computing device, the user identified using facial recognition techniques.

4. The system of claim 1 wherein the first entity is associated with a vehicle, the first entity locating data includes vehicle identifying characteristics, the second entity locating data includes visual data captured by a camera of a mobile device, the location matching condition is satisfied responsive to the matching manager identifying the vehicle identifying characteristics in the visual data captured by the camera of the mobile device.

5. The system of claim 1 wherein the first entity locating data includes audio data of surroundings detectable by a computing device associated with the first entity, the second entity locating data includes audio data generated by the one or more sensors coupled to the at least one computing device, and the location matching condition is satisfied responsive to the matching manager identifying matching patterns in the audio data of surroundings detectable by the computing device associated with the first entity and the audio data generated by the one or more sensors coupled to the at least one computing device.

6. The system of claim 1 wherein the location refining signal includes contemporaneous distance separation data corresponding to a distance between the second entity and the first entity as determined based on the second entity locating data and the first entity locating data.

7. A method for locating a first entity by a second entity using one or more sensors coupled to at least one computing device comprising:
monitoring second entity locating data corresponding to the second entity, at least some of the second entity locating data being derived from a physical proximity of the second entity by the one or more sensors coupled to the at least one computing device;
analyzing the monitored second entity locating data and received first entity locating data corresponding the first entity to determine whether the first entity locating data and the second entity locating data satisfy a location matching condition, satisfaction of the location matching condition indicating that the first entity is located within the physical proximity detectable by the one or more sensors coupled to the at least one computing device; and
generating a location refining signal based on the second entity locating data and the first entity locating data responsive to the second entity locating data and the first entity locating data satisfying the location matching condition, the location refining signal providing guidance to at least one of the second entity and the first entity.

8. The method of claim 7 wherein the first entity locating data includes visual data of physical surroundings of the first entity, the second entity locating data includes visual data generated by the one or more sensors coupled to the at least one computing device, and the location matching condition is satisfied responsive to identifying the physical surroundings in the second entity locating data based on the visual data of the physical surroundings of the first entity.

9. The method of claim 7 wherein the first entity locating data includes visual data of a user associated with the first entity, the second entity locating data includes visual data generated by the one or more sensors coupled to the at least one computing device, and the location matching condition is satisfied responsive to identifying the user associated with the first entity in the visual data generated by the one or more sensors coupled to the at least one computing device, the user identified using facial recognition techniques.

10. The method of claim 7 wherein the first entity is associated with a vehicle, the first entity locating data includes vehicle identifying characteristics, the second entity locating data includes visual data captured by a camera of a mobile device, and the location matching condition is satisfied responsive to identifying the vehicle identifying characteristics in the visual data captured by the camera of the mobile device.

11. The method of claim 7 wherein the first entity locating data includes audio data of surroundings detectable by a computing device associated with the first entity, the second entity locating data includes audio data generated by the one or more sensors coupled to the at least one computing device, and the location matching condition is satisfied responsive to identifying matching patterns in the audio data of surroundings detectable by the computing device associated with the first entity and the audio data generated by the one or more sensors coupled to the at least one computing device.

12. The method of claim 7 wherein the location refining signal includes contemporaneous distance separation data corresponding to a distance between the second entity and the first entity as determined based on the second entity locating data and the first entity locating data.

13. The method of claim 7 wherein the one or more sensors coupled to the at least one computing device are activated responsive to detection of satisfaction of a proximity condition based on a distance between the first entity and the second entity.

14. One or more tangible processor-readable storage media embodied with instructions for executing on one or more processors and circuits of a device a process for locating a first entity by a second entity using one or more sensors coupled to at least one computing device comprising:
monitoring second entity locating data corresponding to the second entity, at least some of the second entity locating data being derived from a physical proximity of the second entity by the one or more sensors coupled to the at least one computing device;
analyzing the monitored second entity locating data and received first entity locating data corresponding the first entity to determine whether the first entity locating data and the second entity locating data satisfy a location matching condition, satisfaction of the location matching condition indicating that the first entity is located within the physical proximity detectable by the one or more sensors coupled to the at least one computing device; and
generating a location refining signal based on the second entity locating data and the first entity locating data responsive to the second entity locating data and the first entity locating data satisfying the location matching condition, the location refining signal providing guidance to at least one of the second entity and the first entity.

15. The one or more tangible processor-readable storage media of claim 14 wherein the first entity locating data includes visual data of physical surroundings of the first entity, the second entity locating data includes visual data generated by the one or more sensors coupled to the at least one computing device, and the location matching condition is satisfied responsive to identifying the physical surroundings in the second entity locating data based on the visual data.

16. The one or more tangible processor-readable storage media of claim 14 wherein the first entity locating data includes visual data of a user associated with the first entity, the second entity locating data includes visual data generated by the one or more sensors coupled to the at least one computing device, and the location matching condition is satisfied responsive to identifying the user associated with the first entity in the visual data generated by the one or more sensors coupled to the at least one computing device, the user identified using facial recognition techniques.

17. The one or more tangible processor-readable storage media of claim 14 wherein the first entity is associated with a vehicle, the first entity locating data includes vehicle identifying characteristics, the second entity locating data includes visual data captured by a camera of a mobile device, the location matching condition is satisfied responsive to identifying the vehicle identifying characteristics in the visual data captured by the camera of the mobile device.

18. The one or more tangible processor-readable storage media of claim 14 wherein the first entity locating data includes audio data of surroundings detectable by a computing device associated with the first entity, the second entity locating data includes audio data generated by the one or more sensors coupled to the at least one computing device, and the location matching condition is satisfied responsive to identifying matching patterns in the audio data of surroundings detectable by the computing device associated with the first entity and the audio data generated by the one or more sensors coupled to the at least one computing device.

19. The one or more tangible processor-readable storage media of claim 14 wherein the first entity locating data includes signal data of wireless signals detected by a computing device associated with the first entity, the second entity locating data includes signal data detected by the one or more sensors coupled to the at least one computing device, and the location matching condition is satisfied responsive to identifying matching patterns between the signal data of the wireless signals detected by the computing device associated with the first entity and the signal data detected by the one or more sensors coupled to the at least one computing device.

20. The one or more tangible processor-readable storage media of claim 14 wherein the one or more sensors coupled to the at least one computing device are activated responsive to detection of satisfaction of a proximity condition based on a distance between the first entity and the second entity.
